(19) United States
(12) Patent Application Publication
(10) Pub. No.: US 2022/0266277 A1
(43) Pub. Date: Aug. 25, 2022

(54) TWO-IN-ONE CLEANING APPARATUS

(71) Applicant: YONGKANG HAILI INDUSTRIAL CO., LTD., Yongkang (CN)

(72) Inventor: Yujun SHAO, Yongkang (CN)

(73) Assignee: YONGKANG HAILI INDUSTRIAL CO., LTD., Yongkang (CN)

(21) Appl. No.: 17/431,163

(22) PCT Filed: Apr. 12, 2021
(86) PCT No.: PCT/CN2021/086504

§ 371 Date: Aug. 15, 2021

(30) Foreign Application Priority Data
May 15, 2020 (CN) 202010413277.2

(51) Int. Cl. B05B 7/24; B08B 3/02; B05B 15/60

(52) U.S. Cl. CPC B05B 7/2464; B08B 3/026; B05B 7/2443; B05B 15/60; B08B 2203/0276; B08B 2203/027; B08B 2203/0217

(57) ABSTRACT

Disclosed is a two-in-one cleaning apparatus. The two-in-one cleaning apparatus includes a positioning assembly, a booster pump, an automatic hose reel, an intermediate connecting rod, and a spray gun body. The booster pump, the automatic hose reel, the intermediate connecting rod, and the spray gun body are all detachably mounted on the positioning assembly. The booster pump is provided with a water inlet and a water outlet, a water inlet pipe is arranged at the water inlet of the booster pump, and the water outlet of the booster pump is connected to the automatic hose reel. The automatic hose reel is provided with a mounting bracket, the positioning assembly is provided with a positioning support plate matching the mounting bracket, and the automatic hose reel is mounted on the positioning assembly through matching between the mounting bracket and the positioning support plate. The spray gun body is detachably connected to the booster pump and the intermediate connecting rod, respectively. The disclosure has the beneficial effects of being convenient to carry, high in stability, wide in application range, capable of meeting different use requirements, convenient to dismount and mount, simple in structure and convenient to operate.

### CROSS-REFERENCE TO RELATED APPLICATIONS

This application claims priority to Chinese Patent Application No. 2020104132772, filed to the China National Intellectual Property Administration (CNIPA) on May 15, 2020 and entitled “TWO-IN-ONE CLEANING APPARATUS”, the entire contents of which are incorporated herein by reference.

### TECHNICAL FIELD

The disclosure relates to the technical field of articles for daily use, in particular to a two-in-one cleaning apparatus.

### BACKGROUND

A booster pump is a pump used for pressure boosting, having main applications such as pressure boosting for water heaters, pressure boosting in cases such as low water pressure, sauna and bathing in high-rise buildings, pressure boosting for insufficient pressure in the uppermost layer of apartments, solar automatic pressure boosting, and pressure boosting for reverse osmosis water purifiers. A winder is also referred to as an automatic hose reel, a wire winder, a reel, or a reel drum, which is widely used in people's daily life and work. Due to its multiple functions, the winder is also referred to as a water reel, an electric reel, a gas reel, and an oil reel according to the functions. However, the existing cleaning apparatus does not effectively integrate the booster pump and the winder. Such a product has a certain limitation in practicability, and needs to be mounted and debugged when used each time. Currently, during use of some of existing cleaning devices with hand winding and hanging functions, the apparatus is easy to be moved and even toppled over when a high-pressure water hose is pulled, and accordingly has low stability and potential safety hazard.

### SUMMARY

In order to overcome the above defects of the conventional art, the disclosure provides a two-in-one cleaning apparatus which is convenient to carry and high in stability.

In order to achieve the above objective, the following technical solutions are adopted.

A two-in-one cleaning apparatus includes a positioning assembly, a booster pump, an automatic hose reel, an intermediate connecting rod, and a spray gun body. The booster pump, the automatic hose reel, the intermediate connecting rod, and the spray gun body are all detachably mounted on the positioning assembly. The booster pump is provided with a water inlet and a water outlet, and the water outlet of the booster pump is connected to the automatic hose reel. The automatic hose reel is provided with a mounting bracket, the positioning assembly is provided with a positioning support plate matching the mounting bracket, and the automatic hose reel is mounted on the positioning assembly through matching between the mounting bracket and the positioning support plate. The spray gun body is detachably connected to the booster pump and the intermediate connecting rod, respectively.

With the design of the positioning assembly, the cleaning apparatus can be fixed conveniently, and can be generally fixed on a wall or other object not easy to move, so that high stability of the booster pump is ensured. The booster pump is placed on the positioning assembly, and accordingly may be taken or placed according to actual needs, so that an application range of the booster pump is greatly expanded. Since the automatic hose reel and the booster pump are detachably connected, the automatic hose reel may be separately used, the automatic hose reel may be directly connected to a water tap for use, and thus the apparatus may be used on the premise without a power supply. The automatic hose reel is positioned on the positioning assembly so that the stability of the automatic hose reel can be improved. With the design of the intermediate connecting rod and the spray gun body, different accessories may be selected according to different service requirements during use of the apparatus, so as to meet requirements of different application ranges. Because all the above components are detachably connected, the cleaning apparatus can be detached into parts from a whole, and accordingly is convenient to carry. After being assembled, the cleaning apparatus has a good storage property, is not required to be re-assembled every time used, and accordingly is convenient to use and store.

Preferably, the positioning assembly includes a main support, two upper connecting rods and two lower connecting rods; the main support is H-shaped; the two upper connecting rods are respectively mounted at two upper ends of the main support, and the two lower connecting rods are respectively mounted at two lower ends of the main support; one end of each upper connecting rod is fixedly connected to the main support; a first positioning holder is arranged at the other end of one upper connecting rod, and a second positioning holder is arranged at the other end of the other upper connecting rod; a buffer sleeve is arranged in the middle of each upper connecting rod; one end of each lower connecting rod is fixedly connected to the main support; a third positioning holder is arranged at the other end of the corresponding lower connecting rod; a limit groove is disposed in the middle of the main support, and the positioning support plate is mounted in the limit groove. With the design of the first positioning holder and the second positioning holder, mounting of the spray gun body and the intermediate connecting rod can be facilitated; and with the design of the positioning support plate and the limit groove, dismounting and mounting of the positioning support plate can be facilitated.

Preferably, the first positioning holder, the second positioning holder, and the third positioning holder are all integrally molded; the first positioning holder is provided with a mounting plate used for mounting of the positioning assembly, a limit block used for limiting the position of the booster pump, and a circular positioning fastener used for positioning the spray gun body; the second positioning holder is provided with another mounting plate used for mounting of the positioning assembly, another limit block used for limiting the position of the booster pump, and a U-shaped positioning fastener used for positioning the intermediate connecting rod; the third positioning holder is provided with yet another mounting plate used for mounting of the positioning assembly; both the first positioning holder and the second positioning holder are in threaded connection with the upper connecting rods, respectively; the third positioning holder is in threaded connection with the corresponding lower connecting rod; the positioning support plate is provided with two positioning flanges and a limit plate; and the mounting bracket is mounted between the two positioning flanges and arranged on the limit plate. With the structural design of the positioning support plate, mounting and positioning of the mounting bracket can be facilitated, the structure is simplified, and the operation is facilitated.

Preferably, clamping platforms are arranged at left and right sides of a middle portion of the booster pump; the booster pump is clamped to the buffer sleeves of the upper connecting rods of the positioning assembly through the clamping platforms; the water inlet and the water outlet are mounted at left and right sides of a lower end of the booster pump; an operating handle is arranged at an upper end of the booster pump; a circular recess is arranged at a joint of the operating handle and the booster pump; a power cord is wound in the circular recess; a gun retainer is arranged on the operating handle, which corresponds to the first positioning holder up to down; the spray gun body is mounted between the gun retainer and the first positioning holder; and a regulating valve is arranged, above one clamping recess, on one lateral side of the booster pump. With the design of the clamping platforms, mounting and positioning of the booster pump on the positioning assembly can be facilitated. With the design of the circular recess, storage of the power cord can be facilitated. With the design of the operating handle and the gun retainer, taking and placing of the booster pump and the spray gun body can be facilitated. With the design of the regulating valve, a pressure of the booster pump can be effectively regulated to meet different requirements.

Preferably, the automatic hose reel is provided with a U-shaped mounting plate that is fixedly mounted on the automatic hose reel; the mounting bracket is U-shaped, and both ends of the mounting bracket are mounted on the U-shaped mounting plate and are in threaded connection with the same; the bottom of the mounting bracket is mounted on the positioning support plate; the automatic hose reel is provided with a hose water inlet and a hose water outlet; the hose water inlet is provided with a mounting nut, and the hose water inlet is in threaded connection with the water outlet on the booster pump through the mounting nut; the hose water outlet is provided with a limiter, the automatic hose reel is provided with a hose outlet, and the hose water outlet is limited at the hose outlet through the limiter; the limiter is shaped as a circular truncated cone, one end, with a minor diameter, of the limiter faces towards the hose outlet; the lateral surface of the limiter is provided with anti-slip recesses; and the hose water outlet and the spray gun body are detachably connected. With the design of the hose water inlet and the mounting nut, demounting and mounting of the automatic hose reel and the bracket of the booster pump are facilitated. With the design of the limiter on the hose water outlet, on the one hand, the hose water outlet can be limited and prevented from entering the automatic hose reel to affect use of the automatic hose reel, and on the other hand, the limiter can be operated conveniently through the design of the anti-slip recesses.

Preferably, a containing box is arranged under the positioning assembly; mounting rails are arranged on an upper end surface of the containing box; cross sections of the mounting rails are T-shaped; one end of each mounting rail is provided with a trapezoidal guide head; a limit step is arranged on the upper end surface of the containing box; a mounting connector is arranged on the mounting rail and mounted on the positioning assembly; the containing box is mounted on the positioning assembly through matching between the mounting rails and the mounting connectors; and a liquid soap kettle and a high-pressure water hose are arranged inside the containing box. With the structural design of the containing box, demounting and mounting of the containing box are facilitated.

Preferably, the mounting connector is integrally molded, a T-shaped groove matching the corresponding mounting rail is disposed at the bottom of the mounting connector; a C-shaped fastener is arranged at the upper end of the mounting connector; and the mounting connector is mounted in the middle of the corresponding lower connecting rod of the positioning assembly through the C-shaped fastener. With the structural design of the mounting connector, demounting and mounting of the mounting connector can be facilitated.

Preferably, the liquid soap kettle includes a kettle body and a kettle nozzle; the kettle body and the kettle containing box are detachably connected; the kettle nozzle is detachably connected to the spray gun body and the intermediate connecting rod, respectively; and the high-pressure water hose is mounted at the water inlet of the booster pump. With the design of the liquid soap kettle, cleaning effects can be further improved to meet different requirements.

Preferably, the spray gun body includes a gun head, a gun grip, and a hose holder; a high-pressure nozzle is disposed on the gun head; the gun grip is provided with a gun button and a button lock catch, and the gun button matches the button lock catch; the hose holder is provided with a hose mounting hole and a hose button, and the hose mounting hole matches the hose button; the gun head is provided with an observation window; guide slots are disposed inside the gun head, and guide bars matching the guide slots are arranged on the lateral surface of the high-pressure nozzle; the observation window comprises a limiting area and a positioning area, and the limiting area corresponds to positions of the guide slots, and the guide bars are clamped in the positioning area of the observation window of the gun head; and the high-pressure nozzle is mounted on the gun head through matching between the guide slots and the guide bars. With the structural design of the spray gun body, on the one hand, normal-on and normal-off of the spray gun body can be ensured by locking the gun button through the button lock catch, on the other hand, demounting and mounting of the high-pressure water hose can be facilitated through the hose button, and further, demounting and mounting between the high-pressure nozzle and the spray gun body can be facilitated with the design of the guide slots.

Preferably, the intermediate connecting rod includes a connecting rod body and the high-pressure nozzle; one end of the connecting rod body is provided with the guide bars, and the connecting rod body is mounted on the gun head through the matching between the guide slots and the guide bars; an internal thread is arranged at the other end of the connecting rod body, an external thread is arranged, below the guide bars, on the high-pressure nozzle, and the connecting rod body is in threaded connection with the high-pressure nozzle. With the structural design of the intermediate connecting rod, demounting and mounting of the intermediate connecting rod can be facilitated, the structure is simplified, and the operation is facilitated.

According to another aspect of the present application, a two-in-one cleaning apparatus is provided, including a positioning assembly, a booster pump, a hose reel, an intermediate connecting rod, and a spray gun body. The booster pump, the hose reel, the intermediate connecting rod, and the spray gun body are all detachably mounted on the positioning assembly, the booster pump is provided with a water inlet and a water outlet, the water outlet of the booster pump is connected to the hose reel, and the spray gun body is detachably connected to the booster pump and the intermediate connecting rod, respectively.

Preferably, the booster pump is arranged above or below, in front or rear of, at left or right side, or inside the hose reel.

Preferably, the hose reel is provided with a mounting bracket, the positioning assembly is provided with a positioning support plate matching the mounting bracket, and the hose reel is mounted on the positioning assembly through matching between the mounting bracket and the positioning support plate.

Preferably, the positioning assembly includes a main support, two upper connecting rods and two lower connecting rods; the main support is H-shaped; the two upper connecting rods are respectively mounted at two upper ends of the main support, and the two lower connecting rods are respectively mounted at two lower ends of the main support; one end of each upper connecting rod is fixedly connected to the main support; a first positioning holder is arranged at the other end of one upper connecting rod, and a second positioning holder is arranged at the other end of the other upper connecting rod; and a limit groove is disposed in the middle of the main support, and the positioning support plate is mounted in the limit groove.

Preferably, the first positioning holder is provided with a mounting plate used for mounting of the positioning assembly, a limit block used for limiting the position of the booster pump, and a circular positioning fastener used for positioning the spray gun body; and the second positioning holder is provided with another mounting plate used for mounting of the positioning assembly, another limit block used for limiting the position of the booster pump, and a U-shaped positioning fastener used for positioning the intermediate connecting rod.

The disclosure has the beneficial effects of being convenient to carry, high in stability, wide in application range, capable of meeting different use requirements, convenient to dismount and mount, simple in structure, and convenient to operate.

### BRIEF DESCRIPTION OF THE DRAWINGS

In order to describe the technical solutions in the specific implementation modes of the disclosure or a conventional art more clearly, the drawings required to be used in descriptions about the specific implementation modes or the conventional art will be simply introduced below. It is apparent that the drawings in the following descriptions are only some implementation modes of the disclosure. Those of ordinary skilled in the art may further obtain other drawings according to these drawings without creative work.

FIG. 1 is a schematic structural diagram of the disclosure.

FIG. 2 is a left view of FIG. 1.

FIG. 3 is a schematic structural diagram of a positioning assembly.

FIG. 4 is a schematic structural diagram of a booster pump.

FIG. 5 is a schematic structural diagram of an automatic hose reel.

FIG. 6 is a schematic structural diagram of a containing box.

FIG. 7 is a schematic structural diagram of a mounting connector.

FIG. 8 is a schematic structural diagram of a liquid soap kettle.

FIG. 9 is a schematic structural diagram of a spray gun body.

FIG. 10 is a schematic structural diagram of a connecting rod body.

FIG. 11 is a schematic structural diagram of a high-pressure nozzle.

In the drawings: 1. spray gun body, 2. booster pump, 3. positioning assembly, 4. automatic hose reel, 5. containing box, 6. high-pressure water hose, 7. liquid soap kettle, 8, mounting connector, 9. intermediate connecting rod, 10. water outlet, 11, first positioning holder, 12, mounting plate, 13, circular positioning fastener, 14. limit block, 15. positioning flange, 16. positioning support plate, 17. main support, 18. buffer sleeve, 19. upper connecting rod, 20. second positioning holder, 21. U-shaped positioning fastener, 22. third positioning holder, 23. lower connecting rod, 24. limit plate, 25. limit groove, 26. gun retainer, 27. operating handle, 28. power cord, 29. circular recess, 30. regulating valve, 31. clamping platform, 32. water inlet, 33. hose water inlet , 34. mounting nut, 35. mounting bracket, 36. U-shaped mounting plate, 37. limiter, 38. hose water outlet, 39. anti-slip recess, 40. hose outlet, 41. limit step, 42. mounting rail, 43. trapezoidal guide head, 44. C-shaped fastener, 45. T-shaped groove, 46. kettle body, 47. kettle nozzle, 48. button lock catch, 49. gun button, 50. hose mounting hole, 51. hose button, 52. observation window, 53. limiting area, 54. positioning area, 55. gun head, 56. hose holder, 57. gun grip, 58. internal thread, 59. guide bar, 60. external thread, 61. connecting rod body, and 62. high-pressure nozzle.

### DETAILED DESCRIPTION OF THE EMBODIMENTS

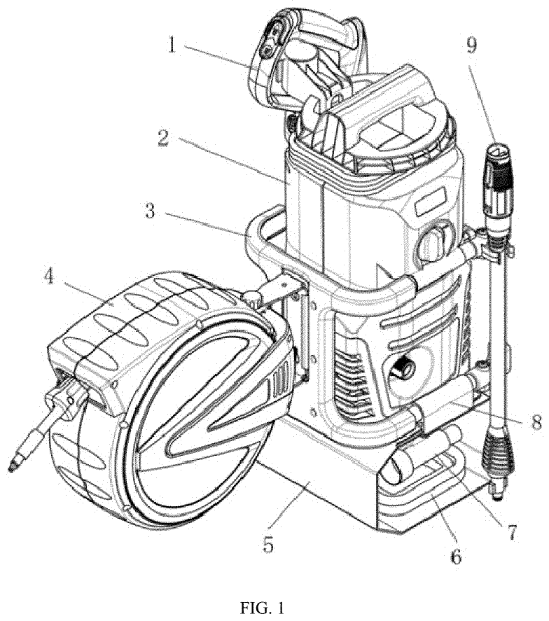

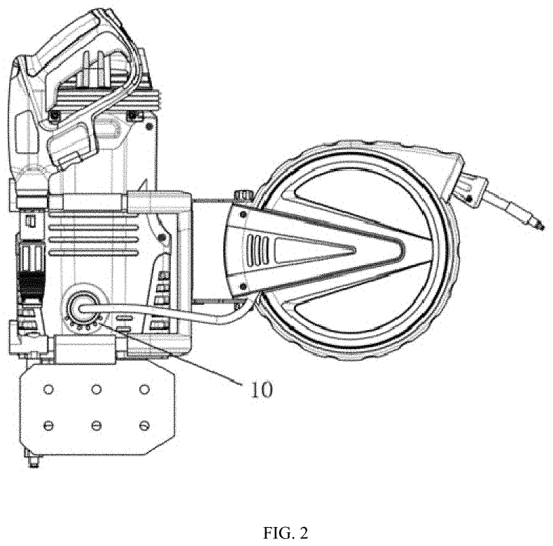

In an embodiment as shown in FIG. 1 and FIG. 2, a two-in-one cleaning apparatus includes a positioning assembly 3, a booster pump 2, an automatic hose reel 4, an intermediate connecting rod 9, and a spray gun body 1. The booster pump 2, the automatic hose reel 4, the intermediate connecting rod 9, and the spray gun body 1 are all detachably mounted on the positioning assembly 3. The booster pump 2 is provided with a water inlet 32 and a water outlet 10, and the water outlet 10 of the booster pump 2 is connected to the automatic hose reel 4. The automatic hose reel 4 is provided with a mounting bracket 35, the positioning assembly 3 is provided with a positioning support plate 16 matching the mounting bracket 35, and the automatic hose reel 4 is mounted on the positioning assembly 3 through matching between the mounting bracket 35 and the positioning support plate 16. The spray gun body 1 is detachably connected to the booster pump 2 and the intermediate connecting rod 9, respectively.

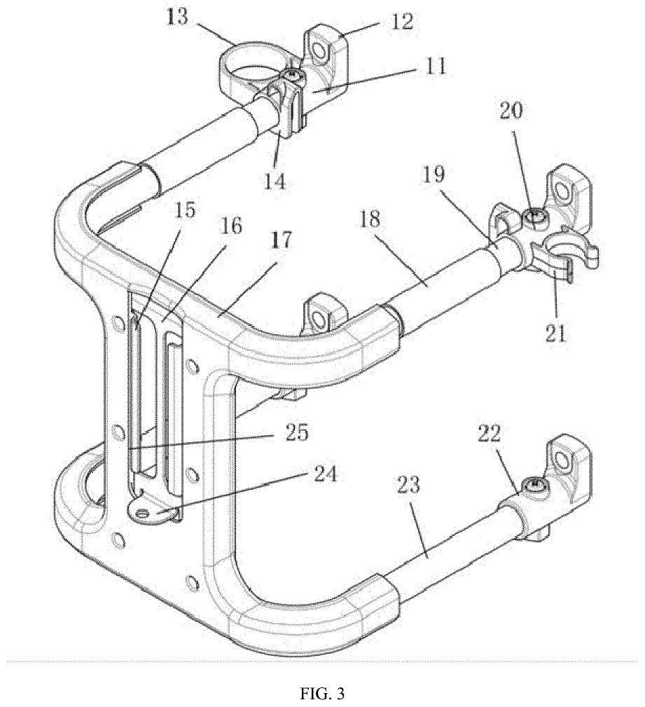

As shown in FIG. 3, the positioning assembly 3 includes a main support 17, two upper connecting rods 19 and two lower connecting rods 23; the main support 17 is H-shaped; the two upper connecting rods 19 are respectively mounted at two upper ends of the main support 17, and the two lower connecting rods 23 are respectively mounted at two lower ends of the main support 17; one end of each upper connecting rod 19 is fixedly connected to the main support 17; a first positioning holder 11 is arranged at the other end of one upper connecting rod 19, and a second positioning holder 20 is arranged at the other end of the other upper connecting rod 19; a buffer sleeve 18 is arranged in the middle of each upper connecting rod 19; one end of each lower connecting rod 23 is fixedly connected to the main support 17; a third positioning holder 22 is arranged at the other end of the corresponding lower connecting rod 23; a limit groove 25 is disposed in the middle of the main support 17, and the positioning support plate 16 is mounted in the limit groove 25. The first positioning holder 11, the second positioning holder 20, and the third positioning holder 22 are all integrally molded; the first positioning holder 11 is provided with a mounting plate 12 used for mounting of the positioning assembly 3, a limit block 14 used for limiting the position of the booster pump 2, and a circular positioning fastener 13 used for positioning the spray gun body 1; the second positioning holder 20 is provided with another mounting plate 12 used for mounting of the positioning assembly 3, another limit block 14 used for limiting the position of the booster pump 2, and a U-shaped positioning fastener 21 used for positioning the intermediate connecting rod 9; the third positioning holder 22 is provided with yet another mounting plate 12 used for mounting of the positioning assembly 3; both the first positioning holder 11 and the second positioning holder 20 are in threaded connection with the upper connecting rods 19, respectively; the third positioning holder 22 is in threaded connection with the corresponding lower connecting rod 23; the positioning support plate 16 is provided with two positioning flanges 15 and a limit plate 24; and the mounting bracket 35 is mounted between the two positioning flanges 15 and arranged on the limit plate 24.

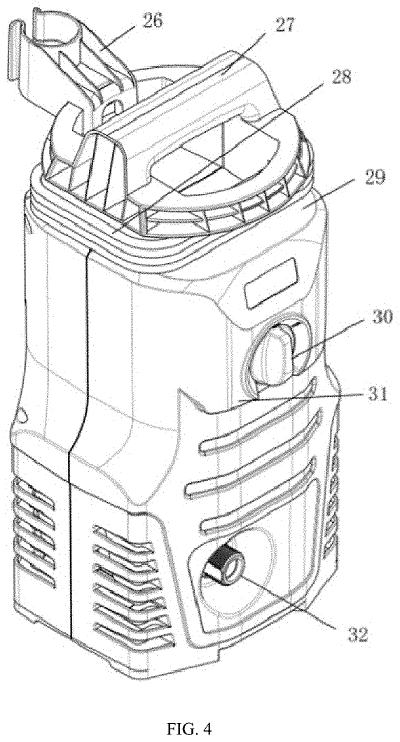

As shown in FIG. 4, clamping platforms 31 are respectively arranged at left and right sides of a middle portion of the booster pump 2; the booster pump 2 is clamped to the buffer sleeves 18 of the upper connecting rods 19 of the positioning assembly 3 through the clamping platforms 31; the water inlet 32 and the water outlet 10 are mounted at left and right sides of a lower end of the booster pump 2; an operating handle 27 is arranged at an upper end of the booster pump 2; a circular recess 29 is arranged at a joint of the operating handle 27 and the booster pump 2; a power cord 28 is wound in the circular recess 29; a gun retainer 26 is arranged on the operating handle 27, which corresponds to the first positioning holder 11 up to down; the spray gun body 1 is mounted between the gun retainer 26 and the first positioning holder 11; and a regulating valve 30 is arranged, above one clamping recess 31, on one lateral side of the booster pump 2.

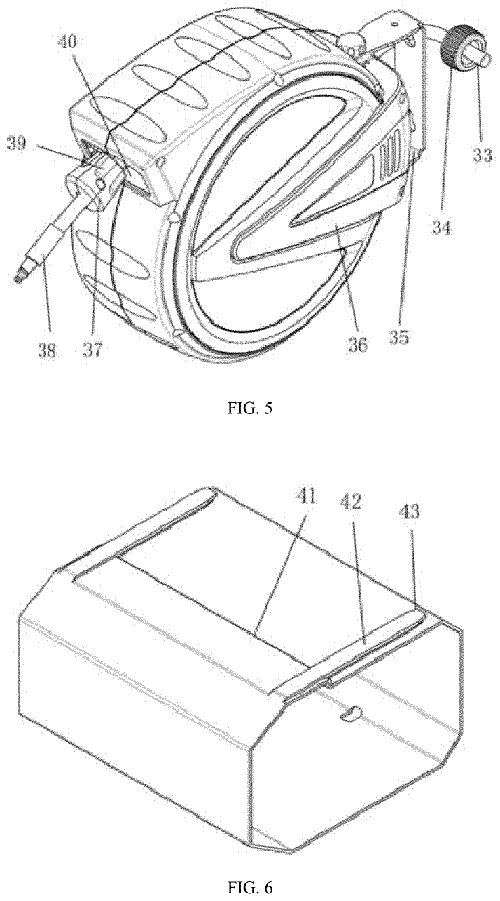

As shown in FIG. 5, the automatic hose reel 4 is provided with a U-shaped mounting plate 36 that is fixedly mounted on the automatic hose reel 4; the mounting bracket 35 is U-shaped, and both ends of the mounting bracket 35 are mounted on the U-shaped mounting plate 36 and are in threaded connection with the same; the bottom of the mounting bracket 35 is mounted on the positioning support plate 16; the automatic hose reel 4 is provided with a hose water inlet 33 and a hose water outlet 38; the hose water inlet 33 is provided with a mounting nut 34, and the hose water inlet 33 is in threaded connection with the water outlet 10 on the booster pump 2 through the mounting nut 34; the hose water outlet 38 is provided with a limiter 37, the automatic hose reel 4 is provided with a hose outlet 40, and the hose water outlet 38 is limited at the hose outlet 40 through the limiter 37; the limiter 37 is shaped as a circular truncated cone, one end, with a minor diameter, of the limiter 37 faces towards the hose outlet 40; the lateral surface of the limiter 37 is provided with anti-slip recesses 39; and the hose water outlet 38 and the spray gun body 1 are detachably connected.

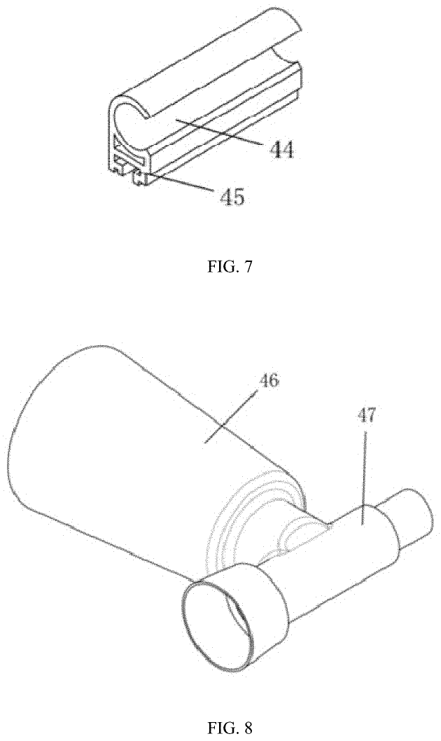

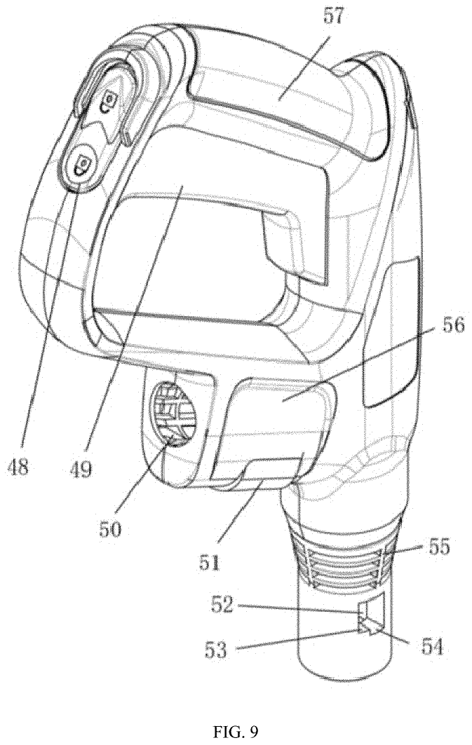

As shown in FIG. 6, a containing box 5 is arranged under the positioning assembly 3, mounting rails 42 are arranged on an upper end surface of the containing box 5; cross sections of the mounting rails 42 are T-shaped; one end of each mounting rail 42 is provided with a trapezoidal guide head 43; a limit step 41 is arranged on the upper end surface of the containing box; a mounting connector 8 is arranged on the mounting rail 42 and is mounted on the positioning assembly 3; the containing box 5 is mounted on the positioning assembly 3 through matching between the mounting rails 42 and the mounting connectors 8; and a liquid soap kettle 7 and a high-pressure water hose 6 are arranged inside the containing box 5. As shown in FIG. 7, the mounting connector 8 is integrally molded, and a T-shaped groove 45 matching the corresponding mounting rail 42 is disposed at the bottom of the mounting connector 8; a C-shaped fastener 44 is arranged at an upper end of the mounting connector 8; the mounting connector 8 is mounted in the middle of the corresponding lower connecting rod 23 of the positioning assembly 3 through the C-shaped fastener 44. As shown in FIG. 8, the liquid soap kettle 7 comprises a kettle body 46 and a kettle nozzle 47 that are detachably connected; the kettle nozzle 47 is detachably connected with the spray gun body 1 and the intermediate connecting rod 9, respectively; and the high-pressure water hose 6 is mounted at the water inlet 32 of the booster pump 2.

As shown in FIG. 9 and FIG. 11, the spray gun body (1) includes a gun head 55, a gun grip 57, and a hose holder 56; a high-pressure nozzle 62 is arranged on the gun head 55; the gun grip 57 is provided with a gun button 49 and a button lock catch 48, and the gun button 49 matches the button lock catch 48; the hose holder 56 is provided with a hose mounting hole 50 and a hose button 51, and the hose mounting hole 50 matches the hose button 51; the gun head 55 is provided with an observation window 52; guide slots are disposed inside the gun head 55, and guide bars 59 matching the guide slots are arranged on the lateral surface of the high-pressure nozzle 62; the observation window 52 includes a limiting area 53 and a positioning area 54, and the limiting area 53 corresponds to positions of the guide slots, and the guide bars 59 are clamped in the positioning area 54 of the observation window 52 of the gun head 55; and the high-pressure nozzle 62 is mounted on the gun head 55 through matching between the guide slots and the guide bars 59.

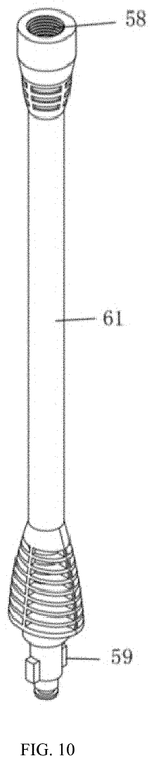

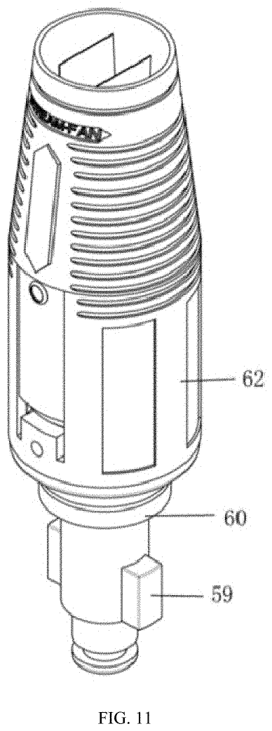

As shown in FIG. 10, the intermediate connecting rod 9 includes a connecting rod body 61 and the high-pressure nozzle 62; one end of the connecting rod body 61 is provided with the guide bars 59, and the connecting rod body 61 is mounted on the gun head 55 through the matching between the guide slots and the guide bars 59; an internal thread 58 is arranged at the other end of the connecting rod body 61, an external thread 60 is arranged, below the guide bars 59, on the high-pressure nozzle 62, and the connecting rod body 61 is in threaded connection with the high-pressure nozzle 62.

Firstly, the positioning assembly 3 is fixedly mounted on a wall through the mounting plates 12 respectively arranged on the first positioning holder 11, the second positioning holder 20, and the third positioning holder 22; secondly, the booster pump 2 is arranged in the positioning assembly 3 through the operating handle 27 on the booster pump 2, here the clamping platforms on the booster pump 2 are respectively clamped to the buffer sleeves 18 of the upper connecting rods 19; after that, the automatic hose reel 4 is mounted on the positioning support plate 16 through the mounting bracket 35, and the mounting bracket 35 is in rotational connection with the U-shaped mounting plate 36 on the automatic hose reel 4; further, the containing box 5 is mounted on the lower connecting rods 23 through the mounting connectors 8, and the liquid soap kettle 7 and the high-pressure water hose 6 are arranged in the containing box 5; finally, the spray gun body 1 is positioned by being arranged between the gun retainer 26 and the circular positioning fastener 13 of the first positioning holder 11, and the intermediate connecting rod 9 is positioned by being arranged on the U-shaped positioning fastener 21 of the second positioning holder 20. During use, the high-pressure water hose 6 is taken out of the containing box 5, one end of the high-pressure water hose 6 is mounted on a water tap or directly placed in water while the other end of the high-pressure water hose 6 is mounted at the water inlet 32 of the booster pump 2; the hose water inlet 33 of the automatic hose reel 4 is mounted at the water outlet 10 of the booster pump 2 through the mounting nut 34; the hose water outlet 38 of the automatic hose reel 4 is mounted on the hose holder 56 of the spray gun body 1; the gun head 55 of the spray gun body 1 may be mounted to the high-pressure nozzle 62, the liquid soap kettle 7, or the intermediate connecting rod 9, and the liquid soap kettle 7 may also be mounted at one end, provided with the high-pressure nozzle 62, of the intermediate connecting rod 9, which only needs to replace the high-pressure nozzle 62 on the intermediate connecting rod 9 with the liquid soap kettle 7. The booster pump 2 or the automatic hose reel 4 may be separately used in the cleaning apparatus. When the booster pump 2 is separately used, both the water inlet 32 and the water outlet 10 are provided with the high-pressure water hose 6, the high-pressure water hose 6 at the water inlet 32 may be mounted on a water tap or directly placed in water, and the high-pressure water hose 6 at the water outlet 10 may be connected to the spray gun body 1 for use or may be directly used. When the automatic hose reel 4 is used separately, the hose water inlet 33 of the automatic hose reel 4 is connected to the water tap, and is used under a pressure of the water tap, and the hose water outlet 38 of the automatic hose reel 4 may be connected to the spray gun body 1 for further use, or may be directly used without being connected to the spray gun body 1.

In another embodiment, the disclosure provides a two-in-one cleaning apparatus, as shown in FIG. 1 and FIG. 2, including a positioning assembly 3, a booster pump 2, a hose reel, an intermediate connecting rod 9, and a spray gun body 1; the booster pump 2, the hose reel, the intermediate connecting rod 9, and the spray gun body 1 are all detachably mounted on the positioning assembly 3, the booster pump 2 is provided with a water inlet 32 and a water outlet 10, the water outlet 10 of the booster pump 2 is connected to the hose reel, and the spray gun body 1 is detachably connected to the booster pump 2 and the intermediate connecting rod 9, respectively.

As shown in FIG. 1, the booster pump 2 is arranged in front of the hose reel, similarly, the booster pump 2 may also be arranged above or below, in front or rear of, at left or right side of, or inside, or at any other positions of the hose reel.

As shown in FIG. 5, the hose reel is provided with a mounting bracket 35, the positioning assembly 3 is provided with a positioning support plate 16 matching the mounting bracket 35, and the hose reel is mounted on the positioning assembly 3 through matching between the mounting bracket 35 and the positioning support plate 16.

As shown in FIG. 3, the positioning assembly 3 includes a main support 17, two upper connecting rods 19 and two lower connecting rods 23; the main support 17 is H-shaped; the two upper connecting rods 19 are respectively mounted at two upper ends of the main support 17, and the two lower connecting rods 23 are respectively mounted at two lower ends of the main support 17; one end of each upper connecting rod 19 is fixedly connected to the main support 17; a first positioning holder 11 is arranged at the other end of one upper connecting rod 19, and a second positioning holder 20 is arranged at the other end of the other upper connecting rod 19; and a limit groove 25 is disposed in the middle of the main support 17, and the positioning support plate 16 is mounted in the limit groove 25.

As shown in FIG. 3, the first positioning holder 11 is provided with a mounting plate 12 used for mounting of the positioning assembly 3, a limit block 14 used for limiting the position of the booster pump 2, and a circular positioning fastener 13 used for positioning the spray gun body 1; and the second positioning holder 20 is provided with another mounting plate 12 used for mounting of the positioning assembly 3, another limit block 14 used for limiting the position of the booster pump 2, and a U-shaped positioning fastener 21 used for positioning the intermediate connecting rod 9.

1. (canceled)

2. A two-in-one cleaning apparatus, comprising a positioning assembly (3), a booster pump (2), an automatic hose reel (4), an intermediate connecting rod (9), and a spray gun body (1), wherein the booster pump (2), the automatic hose reel (4), the intermediate connecting rod (9), and the spray gun body (1) are all detachably mounted on the positioning assembly (3); the booster pump (2) is provided with a water inlet (32) and a water outlet (10); the water outlet (10) of the booster pump (2) is connected to the automatic hose reel (4); the automatic hose reel (4) is provided with a mounting bracket (35); the positioning assembly (3) is provided with a positioning support plate (16) matching the mounting bracket (35); the automatic hose reel (4) is mounted on the positioning assembly (3) through matching between the mounting bracket (35) and the positioning support plate (16); and the spray gun body (1) is detachably connected to the booster pump (2) and the automatic hose reel (4), respectively, wherein the positioning assembly (3) comprises a main support (17), two upper connecting rods (19) and two lower connecting rods (23); the main support (17) is H-shaped; the two upper connecting rods (19) are respectively mounted at two upper ends of the main support (17), and the two lower connecting rods (23) are respectively mounted at two lower ends of the main support (17); one end of each upper connecting rod (19) is fixedly connected to the main support (17); a first positioning holder (11) is arranged at the other end of one upper connecting rod (19), and a second positioning holder (20) is arranged at the other end of the other upper connecting rod (19); a buffer sleeve (18) is arranged in the middle of each upper connecting rod (19); one end of each lower connecting rod (23) is fixedly connected to the main support (17); a third positioning holder (22) is arranged at the other end of the corresponding lower connecting rod (23); and a limit groove (25) is disposed in the middle of the main support (17), and the positioning support plate (16) is mounted in the limit groove (25).

3. The two-in-one cleaning apparatus as claimed in claim 2, wherein the first positioning holder (11), the second positioning holder (20), and the third positioning holder (22) are all integrally molded; the first positioning holder (11) is provided with a mounting plate (12) used for mounting of the positioning assembly (3), a limit block (14) used for limiting the position of the booster pump (2), and a circular positioning fastener (13) used for positioning the spray gun body (1); the second positioning holder (20) is provided with another mounting plate (12) used for mounting of the positioning assembly (3), another limit block (14) used for limiting the position of the booster pump (2), and a U-shaped positioning fastener (21) used for positioning the intermediate connecting rod (9); the third positioning holder (22) is provided with yet another mounting plate (12) used for mounting of the positioning assembly (3); both the first positioning holder (11) and the second positioning holder (20) are in threaded connection with the upper connecting rods (19), respectively; the third positioning holder (22) is in threaded connection with the corresponding lower connecting rod (23); the positioning support plate (16) is provided with two positioning flanges (15) and a limit plate (24); and the mounting bracket (35) is mounted between the two positioning flanges (15) and arranged on the limit plate (24).

4. The two-in-one cleaning apparatus as claimed in claim 2, wherein clamping platforms (31) are arranged at left and right sides of a middle portion of the booster pump (2);
the booster pump (2) is clamped to the buffer sleeves (18) of the upper connecting rods (19) of the positioning assembly (3) through the clamping platforms (31); the water inlet (32) and the water outlet (10) are mounted at left and right sides of a lower end of the booster pump (2); an operating handle (27) is arranged at an upper end of the booster pump (2); a circular recess (29) is arranged at a joint of the operating handle (27) and the booster pump (2); a power cord (28) is wound in the circular recess (29); a gun retainer (26) is arranged on the operating handle (27), which corresponds to the first positioning holder (11) up to down; the spray gun body (1) is mounted between the gun retainer (26) and the first positioning holder (11); and a regulating valve (30) is arranged, above one clamping recess (31), on one lateral side of the booster pump (2).

5. The two-in-one cleaning apparatus as claimed in claim 2, wherein the automatic hose reel (4) is provided with a U-shaped mounting plate (36) that is fixedly mounted on the automatic hose reel (4); the mounting bracket (35) is U-shaped, and both ends of the mounting bracket (35) are mounted on the U-shaped mounting plate (36) and are in threaded connection with the same; the bottom of the mounting bracket (35) is mounted on the positioning support plate (16); the automatic hose reel (4) is provided with a hose water inlet (33) and a hose water outlet (38); the hose water inlet (33) is provided with a mounting nut (34), and the hose water inlet (33) is in threaded connection with the water outlet (10) on the booster pump (2) through the mounting nut (34); the hose water outlet (38) is provided with a limiter (37), the automatic hose reel (4) is provided with a hose outlet (40), and the hose water outlet (38) is limited at the hose outlet (40) through the limiter (37); the limiter (37) is shaped as a circular truncated cone, one end, with a minor diameter, of the limiter (37) faces towards the hose outlet (40); the lateral surface of the limiter (37) is provided with anti-slip recesses (39); and the hose water outlet (38) and the spray gun body (1) are detachably connected.

6. The two-in-one cleaning apparatus as claimed in claim 2, wherein a containing box (5) is arranged under the positioning assembly (3), mounting rails (42) are arranged on an upper end surface of the containing box (5); cross sections of the mounting rails (42) are T-shaped; one end of each mounting guide rail (42) is provided with a trapezoidal guide head (43); a limit step (41) is arranged on the upper end surface of the containing box; a mounting connector (8) is arranged on the mounting rail (42) and is mounted on the positioning assembly (3); the containing box (5) is mounted on the positioning assembly (3) through matching between the mounting rails (42) and the mounting connectors (8); a liquid soap kettle (7) and a high-pressure water hose (6) are arranged inside the containing box (5).

7. The two-in-one cleaning apparatus as claimed in claim 6, wherein the mounting connector (8) is integrally molded, a T-shaped groove (45) matching the corresponding mounting rail (42) is disposed at the bottom of the mounting connector (8); a C-shaped fastener (44) is arranged at the upper end of the mounting connector (8); and the mounting connector (8) is mounted in the middle of the corresponding lower connecting rod (23) of the positioning assembly (3) through the C-shaped fastener (44).

8. The two-in-one cleaning apparatus as claimed in claim 6, wherein the liquid soap kettle (7) comprises a kettle body (46) and a kettle nozzle (47) that are detachably connected; the kettle nozzle (47) is detachably connected with the spray gun body (1) and the intermediate connecting rod (9), respectively; and the high-pressure water hose (6) is mounted at the water inlet (32) of the booster pump (2).

9. The two-in-one cleaning apparatus as claimed in claim 2, wherein the spray gun body (1) comprises a gun head (55), a gun grip (57), and a hose holder (56); a high-pressure nozzle (62) is arranged on the gun head (55); the gun grip (57) is provided with a gun button (49) and a button lock catch (48), and the gun button (49) matches the button lock catch (48); the hose holder (56) is provided with a hose mounting hole (50) and a hose button (51), and the hose mounting hole (50) matches the hose button (51); the gun head (55) is provided with an observation window (52); guide slots are disposed inside the gun head (55), and guide bars (59) matching the guide slots are arranged on the lateral surface of the high-pressure nozzle (62); the observation window (52) comprises a limiting area (53) and a positioning area (54), and the limiting area (53) corresponds to positions of the guide slots, and the guide bars (59) are clamped in the positioning area (54) of the observation window (52) of the gun head (55); and the high-pressure nozzle (62) is mounted on the gun head (55) through matching between the guide slots and the guide bars (59).

10. The two-in-one cleaning apparatus as claimed in claim 9, wherein the intermediate connecting rod (9) comprises a connecting rod body (61) and the high-pressure nozzle (62); one end of the connecting rod body (61) is provided with the guide bars (59), and the connecting rod body (61) is mounted on the gun head (55) through the matching between the guide slots and the guide bars (59); and an internal thread (58) is arranged at the other end of the connecting rod body (61), an external thread (60) is arranged, below the guide bars (59), on the high-pressure nozzle (62), and the connecting rod body (61) is in threaded connection with the high-pressure nozzle (62).

11. (canceled)

12. (canceled)

13. (canceled)

14. A two-in-one cleaning apparatus, comprising a positioning assembly (3), a booster pump (2), a hose reel, an intermediate connecting rod (9), and a spray gun body (1), wherein the booster pump (2), the hose reel, the intermediate connecting rod (9), and the spray gun body (1) are all detachably mounted on the positioning assembly (3), the booster pump (2) is provided with a water inlet (32) and a water outlet (10), the water outlet (10) of the booster pump (2) is connected to the hose reel, and the spray gun body (1) is detachably connected to the booster pump (2) and the intermediate connecting rod (9), respectively, wherein the hose reel is provided with a mounting bracket (35), the positioning assembly (3) is provided with a positioning support plate (16) matching the mounting bracket (35), and the hose reel is mounted on the positioning assembly (3) through matching between the mounting bracket (35) and the positioning support plate (16), wherein the positioning assembly (3) comprises a main support (17), two upper connecting rods (19) and two lower connecting rods (23); the main support (17) is H-shaped; the two upper connecting rods (19) are respectively mounted at two upper ends of the main support (17), and the two lower connecting rods (23) are respectively mounted at two lower ends of the main support (17);
one end of each upper connecting rod (19) is fixedly connected to the main support (17); a first positioning holder (11) is arranged at the other end of one upper connecting rod (19), and a second positioning holder (20) is arranged at the other end of the other upper connecting rod (19); and
a limit groove (25) is disposed in the middle of the main support (17), and the positioning support plate (16) is mounted in the limit groove (25).

15. The two-in-one cleaning apparatus as claimed in claim 14, wherein the first positioning holder (11) is provided with a mounting plate (12) used for mounting of the positioning assembly (3), a limit block (14) used for limiting the position of the booster pump (2), and a circular positioning fastener (13) used for positioning the spray gun body (1); and
the second positioning holder (20) is provided with another mounting plate (12) used for mounting of the positioning assembly (3), another limit block (14) used for limiting the position of the booster pump (2), and a U-shaped positioning fastener (21) used for positioning the intermediate connecting rod (9).
